(19) United States
(12) Patent Application Publication
(10) Pub. No.: US 2006/0003218 A1
(43) Pub. Date: Jan. 5, 2006

(54) On vehicle fuel cell system

(75) Inventors: Takeshi Shiomi, Yokohama-shi (JP); Tetsuo Uozumi, Miura-gun (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/171,359

(22) Filed: Jul. 1, 2005

(30) Foreign Application Priority Data
Jul. 2, 2004 (JP) 2004-196610

(51) Int. Cl. H01M 8/00; H01M 2/10; B60L 11/18

(52) U.S. Cl. 429/34; 180/65.3; 429/12

(57) ABSTRACT

A fuel cell system mounted on a vehicle, including: a fuel cell which is supplied with hydrogen containing gas for generating electric power; a dilution device which dilutes the hydrogen discharged from the fuel cell before discharging the hydrogen to the outside of the system; and a frame member on which at least the fuel cell is mounted to, wherein the dilution device is disposed in a space inside the vehicle in front and outside of the frame member.

### BACKGROUND OF THE INVENTION

1. Field of Invention

The present invention relates to the configuration of a fuel cell system mounted on a vehicle such as an automobile, and in particular, to the configuration of a system provided with a device for diluting discharge gas containing hydrogen unused in power generating reaction in the fuel cell (hereinafter referred to as discharge hydrogen gas), and reducing concentration of hydrogen thereof to discharge it to the outside of the system.

2. Description of Related Art

In the fuel cell mounted on a vehicle, hydrogen gas and air are supplied as fuel gas and oxidant gas to anode and cathode of the fuel cell respectively for power generating reaction thereof.

Some of nitrogen contained in the supplied air moves from the cathode to the anode through an electrolyte membrane provided therebetween, and is to be accumulated in a hydrogen gas circulation system. Moisture contained in the supplied air and some of water generated by the power generating reaction builds up inside the fuel cell.

An on-vehicle fuel cell system needs discharging unwanted gases/liquids such as the accumulated nitrogen and the built-up water to the outside of the system in order to prevent reduction in power generating reaction and in fuel-cell output resulting from the accumulation of impurities such as nitrogen and water. The discharged gases/liquids thus include hydrogen unused in the power generating reaction.

Japanese Patent Application Laid-open Publication No. 2002-289237 discloses an on-board fuel cell system which uses a mixer and a catalyst combustor (hereinafter referred to as a dilution device) to dilute discharge hydrogen gas and lower hydrogen concentration thereof before discharging it to the outside.

### SUMMARY OF THE INVENTION

The above dilution device needs to have a huge volume to dilute the discharge hydrogen gas in order to sufficiently lower hydrogen concentration thereof.

In the case where the dilution device is arranged in the vicinity of sides of a vehicle, the dilution device may be damaged from an impact from outside, resulting in discharging insufficiently diluted discharge-hydrogen-gas outside the vehicle.

The present invention has been made in the light of the above problems. An object of the present invention is to provide an on-vehicle fuel cell system capable of diluting the discharge gas, lowering the hydrogen concentration thereof sufficiently, and mitigating damage to the dilution device from outside impact, for a vehicle having a fuel cell and auxiliaries mounted in a space limited in height, such as a space under the floor thereof.

An aspect of the present invention is a fuel cell system mounted on a vehicle, comprising: a fuel cell which is supplied with hydrogen containing gas for generating electric power and discharges some of the hydrogen unused in the power generation; a dilution device which dilutes the hydrogen discharged from the fuel cell before discharging the hydrogen to the outside of the system; and a frame member on which at least the fuel cell is mounted to, wherein the dilution device is disposed in a space inside the vehicle in front and outside of the frame member.

### BRIEF DESCRIPTION OF THE DRAWINGS

The invention will now be described with reference to the accompanying drawings wherein:

FIG. 1 is a plan view showing a layout of a fuel cell system according to a first embodiment of the present invention, in which a fuel cell and relevant auxiliaries such as a dilution device are mounted on a vehicle;

FIG. 2 is a schematic diagram of the fuel cell system according to the first embodiment;

FIG. 3 is a plan view showing a layout of a fuel cell system according to a second embodiment of the present invention, in which a fuel cell and relevant auxiliaries such as a dilution device are mounted on a vehicle;

FIG. 4 is a plan view showing a layout of a fuel cell system according to a third embodiment of the present invention, in which a fuel cell and relevant auxiliaries such as a dilution device are mounted on a vehicle;

FIG. 5 shows a side view of the vehicle on which the fuel cell system in FIG. 4 is mounted.

### DETAILED DESCRIPTION OF THE PREFERRED EMBODIMENT

Embodiment of the present invention will be explained below with reference to the drawings, wherein like members are designated by like reference characters.

### FIRST EMBODIMENT

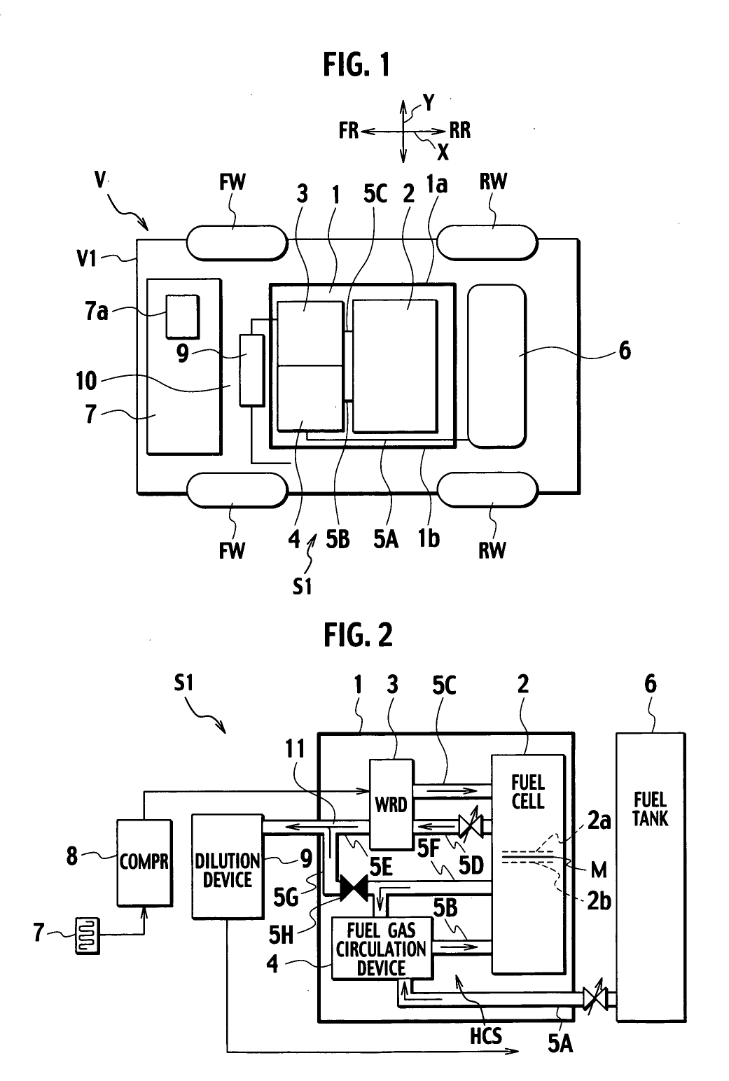

As shown in FIG. 1, there is provided, on a body V1 of a vehicle V between front wheels (FW) and rear wheels (RW), a structural sub frame 1 formed of connected pipes/tubes in a shape of a pallet, for example.

Inside the sub frame 1 are mounted a fuel cell 2 that is the main component of the fuel cell system, a humidifying device or a water recovery device (WRD) 3 as auxiliaries, fuel gas circulating device 4, channels 5A to 5F for passing hydrogen gas used as a fuel gas and air as an oxidant gas, temperature regulating device, power distributing device, and harness (not shown).

The fuel cell 2 introduces hydrogen gas and air thereto to produce electricity by way of an electrochemical reaction between hydrogen contained in hydrogen gas to oxygen contained in the air. Hydrogen gas is supplied from a fuel tank 6 disposed on the rear side in the vehicle longitudinal direction X (for example, behind the rear seat) of the vehicle body V1. The humidifying device 3 is disposed in front of the fuel cell 2 and humidifies hydrogen gas and air to be fed to the fuel cell 2.

The fuel gas circulating device 4 supplies hydrogen gas from the fuel tank 6 to the fuel cell 2, and re-supplies the hydrogen gas discharged from the fuel cell 2 containing hydrogen unused in the power generating reaction therein to the fuel cell 2. The temperature regulating device regulates temperatures in the fuel cell 2 and the fuel cell system S1.

In addition to the above, cooling water is circulated in the fuel cell system S1 to regulate temperatures of fluids in the system.

The channels for passing hydrogen gas and air are described below with reference to FIG. 2. Hydrogen gas is conveyed from the fuel tank 6 to the fuel gas circulating device 4 disposed in front of the fuel cell 2 on the sub frame 1 through the channel 5A connected between the fuel tank 6 and the fuel gas circulating device 4. The hydrogen gas introduced into the fuel gas circulating device 4 is heated and increased in temperature with the temperature regulating device, and then is pumped to the fuel cell 2 by a circulating pump or an ejector, not shown, in the fuel gas circulating device 4 through the channel 5B connected between the fuel gas circulating device 4 and the fuel cell 2.

On the other hand, air is introduced from the inside of a motor compartment 7 where an electric motor 7a for driving the vehicle V is disposed, and compressed by a compressor 8 and conveyed to the humidifying device 3 on the sub frame 1. The air introduced into the humidifying device 3 is here humidified and then supplied to the fuel cell 2 via the channel 5C connected between the humidifying device 3 and the fuel cell 2. The fuel cell 2 generates electric power by way of the reaction of the hydrogen gas with the air. The generated power is fed to the electric motor 7a in the motor compartment 7, which generates torque to be transmitted to the axles of the vehicle V.

The air introduced into the fuel cell 2 is used for the power generating reaction in the fuel cell 2 and then discharged as a moistened discharge air therefrom. The discharge air from the fuel cell 2 passes through the channel 5D connected between the fuel cell 2 and the humidifying device 3 and is introduced into the humidifying device 3. The air introduced into the humidifying device 3 passes through a compressor, not shown, gives moisture thereof to air to be supplied to the fuel cell 2 and then passes through the channel 5E connected between the humidifying device 3 and the channel 5E, reaching a dilution device 9.

On the other hand, the hydrogen gas used for power generation in the fuel cell 2 is discharged from the channel 5F as discharge hydrogen gas containing hydrogen unused in the power generating reaction. In normal operation, the discharge hydrogen gas is conveyed to the fuel gas circulating device 4, merged there with hydrogen gas introduced from the fuel tank 6, and supplied again to the fuel cell 2 for power generating reaction. The reuse of the hydrogen gas thus circulated makes it possible to increase the flow rate of hydrogen gas in the fuel cell 2 while maintaining the flow rate of hydrogen gas supplied from the fuel tank 6 matched with the hydrogen gas consumption rate in the power generation reaction in the fuel cell 2 whereby the power generating reaction thereof becomes stable.

When the fuel cell 2 is continuously operated, some of nitrogen contained in the air supplied to fuel cell 2 moves from cathode 2a to anode 2b via electrolyte membrane M therebetween, and accumulates inside a hydrogen gas circulating system HCS which consists of a channel of the anode 2b in the fuel cell 2, fuel gas circulating device 4, channels 5F and 5B, and so forth. Additionally, water vapor contained in the air and some of water produced by the power generating reaction builds up inside the fuel cell 2. The accumulation of these impurities such as nitrogen and water results in inhibiting hydrogen from reacting with oxygen in the fuel cell 2 to decrease the output of the fuel cell 2. To avoid such disadvantage, the fuel cell system S1 has to discharge a hydrogen-containing gas in the hydrogen gas circulating system HCS from the system to remove impurities accumulated in the system every predetermined time interval.

The gas discharge channel 5G is connected to the outside through the dilution device 9, which is opened to the atmosphere. Therefore opening a valve 5H provided on the gas discharge channel 5G allows impurities-containing gas in the hydrogen gas circulating system HCS to be conveyed to the dilution device 9, mixed with the discharge air therein, diluted to such an extent that a concentration of hydrogen is sufficiently low, and then discharged to the atmosphere.

The principle part of the present invention will be described below with reference to FIG. 1. As shown in FIG. 2, the discharge hydrogen gas from the fuel cell 2 is conveyed to the dilution device 9 through the valve 5H and the channel 5G. In the dilution device 9, the discharge air is also introduced from the cathode 2a of fuel cell 2. The dilution device 9 serves to mix the discharge hydrogen gas with the discharge air, to dilute the discharge hydrogen gas to a sufficient low concentration of hydrogen, at which it is less combustible, and to discharge it to the outside.

In the present embodiment, the dilution device 9 is disposed not inside the sub frame 1, but at a front space 10 outside the sub frame 1 in the rear of the motor compartment 7 (hereinafter referred to as sub-frame front space). In the sub-frame front space 10, there exist only pipes and wires for connecting equipment inside the motor compartment 7 to those inside the sub frame 1, affording a larger space than the inside of the sub frame 1. This makes possible to increase the volume of the dilution device 9 to improve the dilution capacity.

Since it is unnecessary to arrange the channel 5G or the channel for discharging the discharge hydrogen gas across the vehicle transversely outer sides 1a and 1b of the sub frame 1, stiffness of the sub frame 1 can be maintained high. Further, since the front portion of the sub frame 1 is provided with a hole or formed to have a lowered top to connect the pipes and wires between the equipment inside the motor compartment 7 to those inside the sub frame 1, the sub frame 1 can maintains its stiffness.

Furthermore in the present embodiment, since the auxiliaries of the fuel cell system S1 such as the humidifying device 3 and the fuel gas circulating device 4 is disposed in front of the sub frame 1, the distance from the auxiliaries to the dilution system 9 disposed in the sub-frame front space 10 is shortened, reducing a time required for discharging gases outside as well.

A merging point 11 of the discharge gas channels 5E and 5G are positioned inside the sub frame 1 in the present embodiment, but it can be laid outside the sub frame 1. Two discharge channels 5E and 5F are provided for the cathode 2a and anode 2b respectively, but the channels may be increased in number depending upon the configuration of fuel cell system S1. The discharge channels 5E and 5F can be connected directly to the dilution device 9 and then merged therein, alternatively they can be merged upstream as shown in the present embodiment.

### SECOND EMBODIMENT

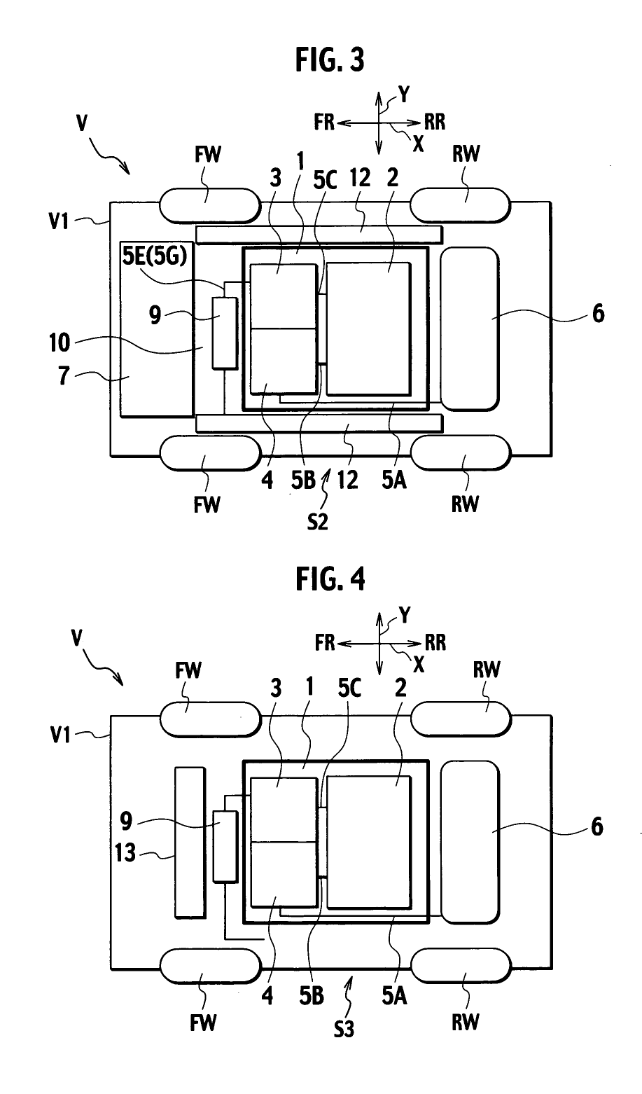

FIG. 3 shows a second embodiment to which the present invention is applied, and illustrates a layout of a vehicle on which a fuel cell system S2 including a fuel cell and auxiliaries such as a dilution device is mounted.

In the present embodiment, the dilution device 9 is disposed in a space in front and outside of the sub frame 1 and between structural side-frame members 12 of the vehicle body V1 extending in the vehicle longitudinal direction X along both outer sides in the vehicle transverse direction Y, in the front part of the body V1 of the vehicle V. As is the case with the first embodiment, the discharge gas channels 5E and 5G from the cathode 2a and anode 2b of the fuel cell 2 are connected to the dilution device 9 disposed in front of the sub frame 1.

In this embodiment, even if the vehicle V is subjected to a side impact in the vehicle transverse direction Y due to a lateral collision, the dilution device 9 is hardly damaged since the device 9 is thus disposed between the side members 12, so that the members absorb the impact load. For that reason the discharge hydrogen gas can be diluted to a sufficiently low hydrogen concentration and discharged outside the vehicle by the use of the dilution device 9 even under those situations.

In FIG. 3, the dilution device 9 is disposed in a space in front and outside of the sub frame 1 and between side members 12 in the front of the car body V1 of the vehicle V, but the same effect can also be achieved by disposing the device 9 between the front wheels FW. That is to say, even if the vehicle V is subjected to an impact from the sides of the vehicle V, the front wheels FW will absorb the impact load, thereby reducing damages to the dilution device 9.

### THIRD EMBODIMENT

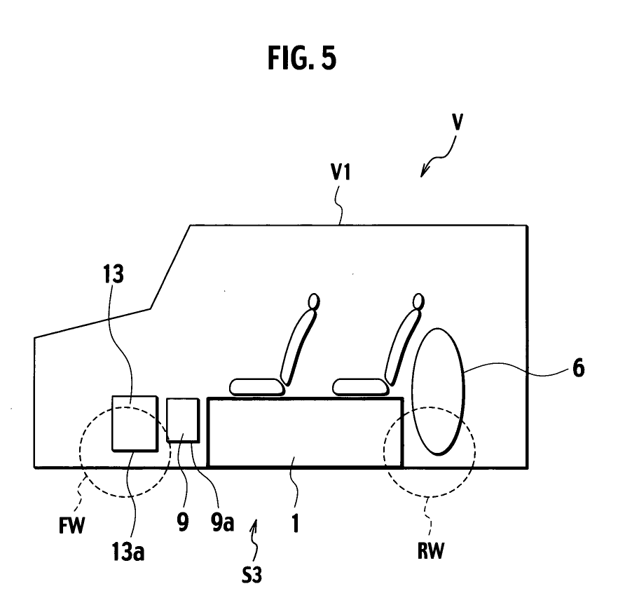

FIG. 4 is a top view showing a third embodiment to which the present invention is applied, and illustrates a layout of a vehicle on which a fuel cell system S3 including a fuel cell and auxiliaries such as a dilution device is mounted. FIG. 5 is a side view of the vehicle on which the fuel cell system shown in FIG. 4 is mounted.

In the present embodiment, the dilution device 9 is disposed in a space at the rear of a front suspension member 13 and in front and outside of the sub frame 1 (that is to say, in a space between the sub frame 1 and the front suspension member 13) in front part of the body V1 of the vehicle V. The dilution device 9 is arranged at the same height position as the front suspension member 13 (that is to say, the dilution device 9 and the front suspension member 13 are arranged so that the projections in the vehicle longitudinal direction X thereof are overlapped on each other and the lower end 9a of the device 9 is at least higher than the lower end 13a of the front suspension member 13). As is the case with the first embodiment, the discharge gas channels 5E and 5G from the cathode 2a and anode 2b of the fuel cell 2 are connected to the dilution device 9 disposed in front of the sub frame 1.

Even if the vehicle V is subjected to a front impact due to a frontal collision, the dilution device 9 is hardly damaged since the device 9 is disposed between the sub frame 1 and front suspension member 13, so that the member absorbs the impact load. For that reason the discharge hydrogen gas can be diluted to a sufficiently low hydrogen concentration and discharged outside the system by the use of the dilution device 9 even under those situations.

In addition to the above, in the present embodiment, even if the vehicle V runs on to obstacles for example curbs on a road, not the dilution device 9 but the front suspension member 13 first hits the obstacle because the device is arranged at the same height position as the front suspension member 13. For that reason the dilution device 9 can avoid damages even under those situations and dilute the discharge hydrogen gas to a sufficiently low hydrogen concentration and discharge it outside the vehicle.

### Other Embodiments

The preferred embodiments described herein are illustrative and not restrictive, and the invention may be practiced or embodied in other ways without departing from the spirit or essential character thereof.

For example, in the first, second, and third embodiments, the dilution device 9 performs dilution by mixing the discharge hydrogen gas from the anode 2b with the discharge air from the cathode 2a and it is sufficient for the device only to hold a large capacity. Alternatively the dilution device 9 may be replaced with a combustor for burning a mixture of the discharge air from the cathode 2a with the discharge hydrogen gas from the anode 2b or a catalyst device for reducing a hydrogen concentration of the discharge gas by the use of catalyst reaction. Such combustor and catalyst device are more preferable because they are capable of diluting the discharge hydrogen gas to lower hydrogen concentration than ordinary gas-mixture dilution device.

In the above embodiments, the dilution device 9 is disposed in the space 10 at the front of the sub frame 1 and between side members 12 or between the sub frame 1 and the front suspension member 13. The device may be disposed at a position completely satisfying the above, that is to say, in the space 10 at the front of the sub frame 1, between side members 12, and between the sub frame 1 and the front suspension member 13. It is more preferable that disposing the dilution device 9 in such a position to reduce an impact load to the device if the vehicle V1 is subjected to an impact from the front or the side of the vehicle V1.

As is the same with the first, second, and third embodiments, the other embodiments described above are capable of diluting the discharge hydrogen gas, lowering the hydrogen concentration thereof sufficiently before discharging it to the outside, and in a vehicle having the fuel cell 2 and auxiliaries mounted in a limited space in particular under the floor of the body V1, mitigating damage to the dilution device from a impact load from the outside.

The scope of the invention being indicated by the claims, and all variations which come within the meaning of claims are intended to be embraced herein.

The present disclosure relates to subject matters contained in Japanese Patent Application No. 2004-196610, filed on Jul. 2, 2004, the disclosure of which is expressly incorporated herein by reference in its entirety.

What is claimed is:

1. A fuel cell system mounted on a vehicle, comprising:
a fuel cell which is supplied with hydrogen containing gas for generating electric power and discharges some of the hydrogen unused in the power generation;
a dilution device which dilutes the hydrogen discharged from the fuel cell before discharging the hydrogen to the outside of the system; and
a frame member on which at least the fuel cell is mounted to, wherein the dilution device is disposed in a space inside the vehicle in front and outside of the frame member.

2. The fuel cell system according to claim 1, wherein
the dilution device is disposed at the rear of a motor compartment of the vehicle.

3. The fuel cell system according to claim 1, wherein
the dilution device is disposed between side members extending in a vehicle longitudinal direction along transversely outer sides of the vehicle.

4. The fuel cell system according to claim 1, wherein
the dilution device is disposed between front wheels of the vehicle.

5. The fuel cell system according to claim 1, wherein
the dilution device is disposed in a position between the frame member and a front suspension member in front of the frame member and higher than the lower end of the front suspension member.
